(19) United States
(12) Patent Application Publication
(10) Pub. No.: US 2019/0101113 A1
(43) Pub. Date: Apr. 4, 2019

(54) System and Method for a Multiple Plunger Reciprocating Gear

(71) Applicant: Predominant Pumps & Automation Solutions LLC, Houston, TX (US)

(72) Inventor: Seth A Douglas, III, Houston, TX (US)

(73) Assignee: Predominant Pumps & Automation Solutions LLC, Houston, TX (US)

(21) Appl. No.: 16/107,643

(22) Filed: Aug. 21, 2018

Related U.S. Application Data
(60) Provisional application No. 62/555,016, filed on Sep. 6, 2017.

(51) Int. Cl. F04B 49/06; F16H 19/04; F04B 17/03

(52) U.S. Cl. CPC F04B 49/065; F04B 17/03; F16H 19/043

(57) ABSTRACT

A reciprocating injection pump is disclosed including but not limited to a reciprocating block driven by a rotating gear, the gear having a substantially circular shape with four gear teeth formed on the rotating gear along approximately one fourth of the substantially circular shape, the rotating gear is attached to a rotating motor, the rotating motor having a right-angle motor shaft.

### CROSS REFERENCE TO RELATED PATENT APPLICATIONS

This patent application claims priority from U.S. Provisional Patent Application Ser. No. 62/555,016 filed on 6 Sep. 2017 by Seth A Douglas entitled A System and Method for a Reciprocating Injection Pump which is hereby incorporated by reference herein in its entirety.

### BACKGROUND OF THE INVENTION

Oil field pump wear out and leak causing expensive down time for repair and replacement during oil production.

### FIELD OF THE INVENTION

A system and method for pumping that reduces expensive down time for repair and replacement during oil field production.

### BRIEF DESCRIPTION OF THE DRAWINGS

FIG. 1, is a plan view of an illustrative embodiment of the invention;

FIG. 2, is a plan view of another particular embodiment a processor and computer readable medium having computer instructions stored therein that are executed by the process to control a stepper motor;

FIG. 3, is a plan view of another particular illustrative embodiment of the invention is schematically depicted showing three plungers attached to a right end of a reciprocating block and another three plungers attached to a left end of the reciprocating block;

FIGS. 4A and 4B are plan views of particular illustrative embodiments of the invention is schematically depicted showing six plungers attached to the right end of the reciprocating block and another six plungers attached to the left end of the reciprocating block.

FIG. 5 is a plan view of another particular illustrative embodiment of the invention is schematically depicted showing the reciprocating block drives 12 plungers that are used to drive 12 pumps.

FIG. 6 is a plan view of another illustrative embodiment of the invention a pump head schematically depicted.

FIGS. 7A, 7B and 7C are plan views of the packing gland is made up of six packing glands. The six packing glands are geometrically shaped to mate with adjacent packing glands to for a stacked set of six packing glands to form the packing gland set shown in FIG. 5.

FIG. 8 is a plan view of a particular illustrative embodiment of the invention, the sixth packing gland element is a spring-loaded section that is convex on the bottom and flat on the top.

FIGS. 9A and 9B are plan views of another particular embodiment of the invention the plungers drive an injection pump.

FIG. 10 is a plan view of a schematic of a safety ring is attached through an opening in a flat surface on the atomizer.

FIG. 11 is a plan view of a detail schematic of the safety ring is shown.

FIG. 12A is a plan view of a schematic depiction of an illustrative embodiment of a collapsible tank stand setup and deployed and ready to support a tank.

FIG. 12B is a plan view of a schematic depiction of the collapsible tank stand collapsed and folded up for transport.

FIG. 13 is a plan view of a particular illustrative embodiment, a hydraulic injection pump system is schematically depicted having a two-pump combination for providing a low-power consumption electrical solution to pumping injection fluid into a subterranean hydrocarbon-bearing formation;

FIG. 14 is a plan view of a particular illustrative embodiment, a hydraulic injection pump system is schematically depicted having a two-pump combination for providing a low-power consumption electrical solution to pumping injection fluid into a subterranean hydrocarbon-bearing formation; and

FIG. 15 is a plan view of a particular illustrative embodiment, a hydraulic injection pump system is schematically depicted having a two-pump combination for providing a low-power consumption electrical solution to pumping injection fluid into a subterranean hydrocarbon-bearing formation.

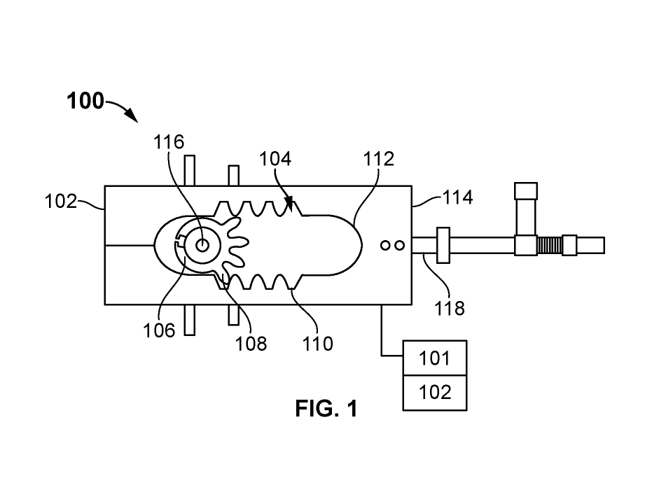

Turning now to FIG. 1A, in an illustrative embodiment of the invention as schematically depicted shown in FIG. 1A, a reciprocating block 100 is driven by a rotating gear 106 having a substantially circular shape with four gear teeth 108 formed on the rotating gear along approximately one fourth of the substantially circular shape. The rotating gear is attached to a rotating motor 115 the rotating motor having a right-angle motor shaft 116. The motor shaft 116 is connected to the right-angle motor a minimal distance minimizing the length of the motor shaft to reduce torque losses associated with longer shaft lengths. The rotating gear is mounted on the motor shaft adjacent the motor from the entry point of the shaft to the motor to reduce torque loss incurred that would occur if the rotating gear was attached further away from the motor and thus having a longer shaft length from where the shaft exits the motor and attaches to the rotating gear. The rotating motor shaft is directly coupled to rotating gear 106 so that gear teeth 108 are rotated by the rotating motor shaft and during rotation, the rotating gear teeth alternately engage the upper gear teeth 104 and lower gear teeth 110 formed inside of the block. The rotating gear causes the reciprocating block to linearly translate back and forth along a longitudinal axis of a plunger 118. The plunger drives an injection pump used to inject chemicals into a hydrocarbon bearing formation in an oil field.

In a particular illustrative embodiment of the invention the rotating gear rotates clockwise causing rotating gear teeth 108 to alternately engage upper block gear teeth 104 and moves the reciprocating block 100 to the right along the longitudinal axis plunger 118. After the rotating gear teeth exit the upper gear teeth the rotating gear teeth alternately engage lower block gear teeth 110 and moves the reciprocating block 100 to the left along the longitudinal axis plunger 118. The plunger is used to pump injection fluids. The reciprocating block is formed having a right end 114 and a left end 102. In FIG. 1A, a single plunger 118 is attached to the right end of the block.

Turning now to FIG. 1C, in another particular embodiment a processor 101 and computer readable medium 102 having computer instructions stored therein that are executed by the process to control the stepper motor 115. is provided the motor 115 is a stepper motor wherein the shaft of the stepper motor is directly coupled to rotating gear 106. The stepper motor steps to rotate the motor shaft clockwise a programmable number of degrees less that a 360 degrees and less that full rotation of the motor shaft to move the right end of the lock to the right. The processor then reverses the direction of the stepper motor to rotate the motor shaft counter clock wise programmable number of degrees less that 360 degrees and less that full rotation of the motor shaft to move the left end of the lock to the left. The stepper motor enables the processor to move the block to the right a distance, for example 2 inches and move the block to the left a different distance, for example 1 inch. The gear teeth 108 are rotated by the stepper motor shaft clockwise so that the gear teeth engage the upper gear teeth 104 so that the sand lower gear teeth 110 formed inside of the block. The stepper motor motion controlled by the stepper motor causes the reciprocating block to linearly translate back and forth along a longitudinal axis of a plunger 118. In a particular embodiment, the translation to the left is 1 inch and the translation to the right is 2 inches.

In another illustrative embodiment of the invention, as schematically depicted in FIG. 1B, the first plunger 118 and a second plunger 120 are attached the left end 102 of the block 100 are caused to linearly translate along the longitudinal axis. In a second illustrative embodiment of the invention as shown in FIG. 1B, the reciprocating block drives both plungers 102 and 120 back and forth along the common longitudinal axes of plungers 118 and 120. In the particular illustrative embodiment of the invention shown in FIG. 1B the reciprocating block drives two plungers 102 and 120 that are used to drive two fuel injection pumps.

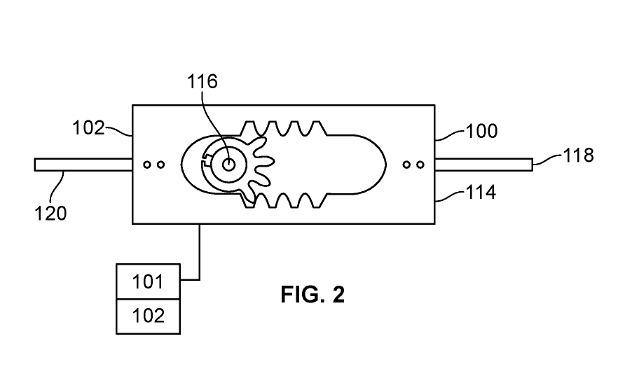

Turning now to FIG. 2, another particular illustrative embodiment of the invention is schematically depicted showing three plungers 202, 204 and 206 are attached to the right end 114 of the reciprocating block 100 and another three plungers 208, 210 and 212 are attached to the left end 114 of the reciprocating block 100. In the particular illustrative embodiment of the invention shown in FIG. 2 the reciprocating block drives 6 plungers 202, 204, 206, 208, 210 and 212 that are used to drive 6 pumps.

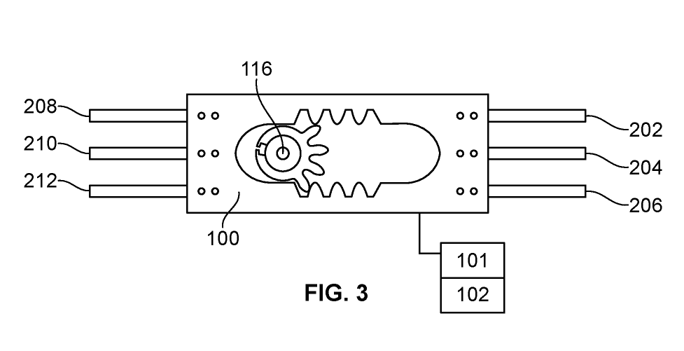

Turning now to FIG. 3, another particular illustrative embodiment of the invention is schematically depicted showing six plungers 202, 203, 204, 205, 206 and 207 are attached to the right end 114 of the reciprocating block 100 and another six plungers 208, 209, 210, 211, 212, 213, 208, 209, 210, 211, 212 and 213 are attached to the left end 114 of the reciprocating block 100. In the particular illustrative embodiment of the invention shown in FIG. 3 the reciprocating block drives 12 plungers 202, 203, 204, 205, 206, 207 208, 209, 210, 211, 212 and 213 and that are used to drive 12 pumps.

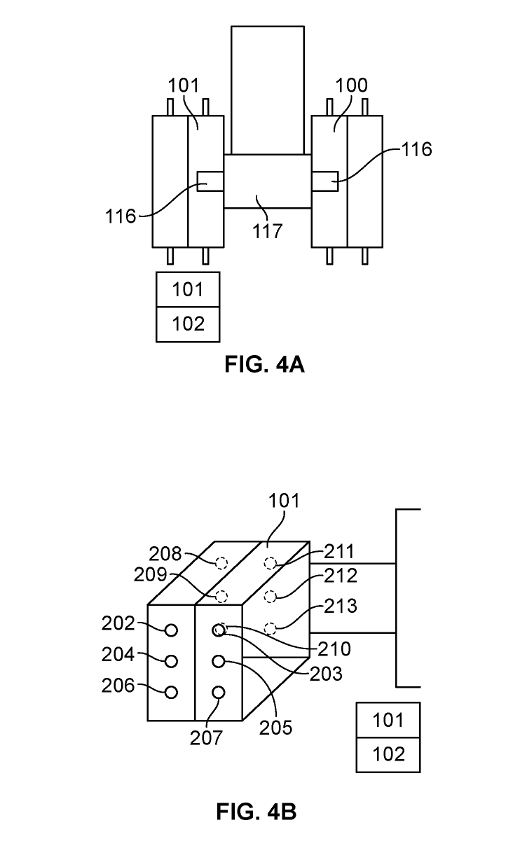

Turning now to FIG. 4 another particular illustrative embodiment of the invention is schematically depicted showing six plungers 202, 203, 204, 205, 206 and 207 are attached to the right end 114 of the reciprocating block 100 and another six plungers 208, 209, 210, 211, 212 and 213 and 208, 209, 210, 211, 212 and 213 are attached to the left end 114 of the reciprocating block 100. In the particular illustrative embodiment of the invention shown in FIG. 3 the reciprocating block drives 12 plungers 202, 203, 204, 205, 206 and 207, 208, 209, 210, 211, 212 and 213 and that are used to drive 12 pumps.

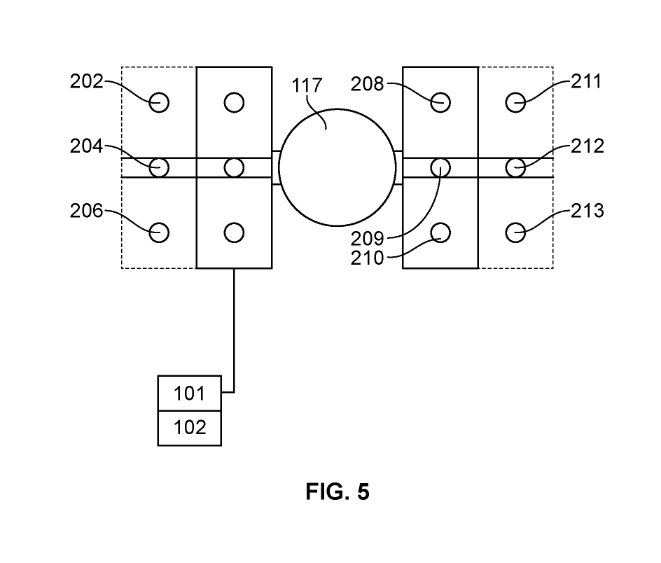

Turning now to FIG. 5 another illustrative embodiment of the invention a pump head 500 schematically depicted. The pump head having flat surfaces 512 to facilitate maintenance and tightening of the pump head. Prior pump heads have typically been round tubular shaped and not easily engaged with a wrench for maintenance. The flat surfaces make engagement of a wrench on the flat surface easier for maintenance and tightening of the pump head. In a particular illustrative embodiment, the pump head has a hexagonal cross section along a longitudinal axis of the pump head. The hexagonal cross section of the pump head provides six flat surfaces with three sets of opposing flat surfaces for engagement with a wrench. In another embodiment the pump head has a square cross section.

As shown in FIG. 5, a packing set is provided. The packing set is made up of 6 packing glands. A spring-loaded packing gland is provided as a sixth gland in the 6 packing glands as schematically depicted in FIG. 5. In a particular embodiment as shown in FIG. 5 the head has a hexagonal shape in cross section perpendicular to a longitudinal axis of the head through which a plunger translates through a packing gland set.

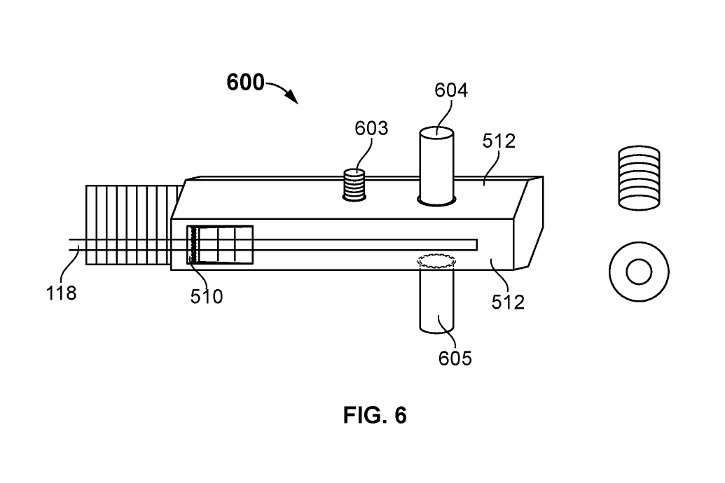

Turning now to FIG. 6, the packing gland is made up of six packing glands. The six packing glands are geometrically shaped to mate with adjacent packing glands to for a stacked set of six packing glands to form the packing gland set shown in FIG. 5. Packing gland 1 is flat on the bottom and concave on the top. The second, third fourth and fifth packing gland element are concave on the bottom and convex on the top. The sixth packing gland element is spring loaded and has a convex bottom and flat top.

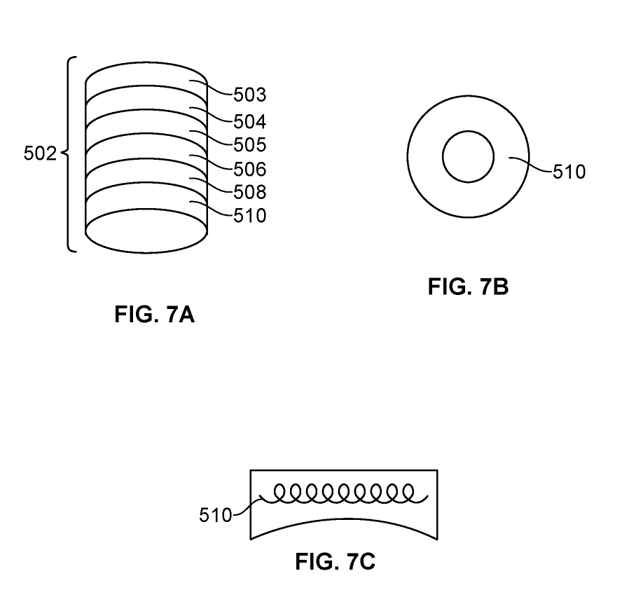

Turning now to FIG. 7, as shown in FIG. 7, in a particular illustrative embodiment of the invention, the sixth packing gland element is a spring-loaded section that is convex on the bottom and flat on the top. The sixth packing gland element which is spring-loaded expands outwardly in a radial direction under pressure to packing nut as the packing nut is tightened. The outward expansion of spring loaded packing glands seals the outside surface of the spring-loaded packing gland to substantially reduce leakage of injection fluid from pump head during operation of the injection pump.

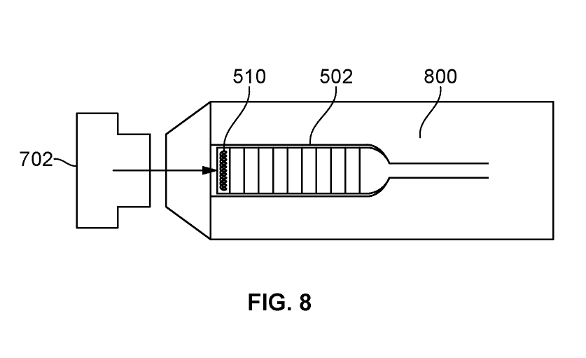

Turning now to FIG. 8, in another particular embodiment of the invention the plungers drive an injection pump. Discharge from the injection pump to an injection line 914 attached to the injection pump is directed to an injection link atomizer.

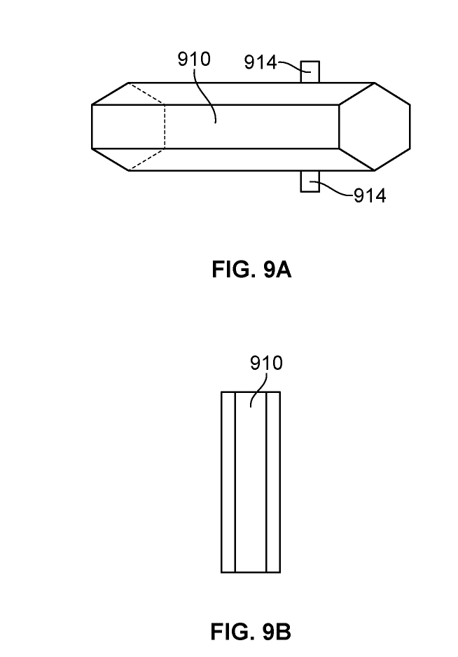

Turning now to FIG. 9A, as shown in FIG. 9A a safety ring is attached through an opening in a flat surface on the atomizer 910. A chain 912 is attached to the safety ring on one end and a fixed member on the pump at the other end. A thermal couple fitting is provided along with a two-piece chevron packing through which a plunger passes. A detail of the safety ring is shown in FIG. 9B. The safety ring has a removable link 905 to enable sliding the safety ring 904 through hole formed on the flat surface of the atomizer 910. A packing set 902 such as a chevron style packing set is provided inside the atomizer 910. In another particular embodiment the packing set includes but is not limited to a spring loaded packing gland to help seal the atomizer and prevent leaking of injection fluid. A tube 914 carries injection fluid through a thermos-coupling 906. The thermos-coupling has external threads 906 formed on one end of the thermos-couple that engage internal threads 910 formed on the atomizer and seal the connection of pumping injection fluid tube to the atomizer.

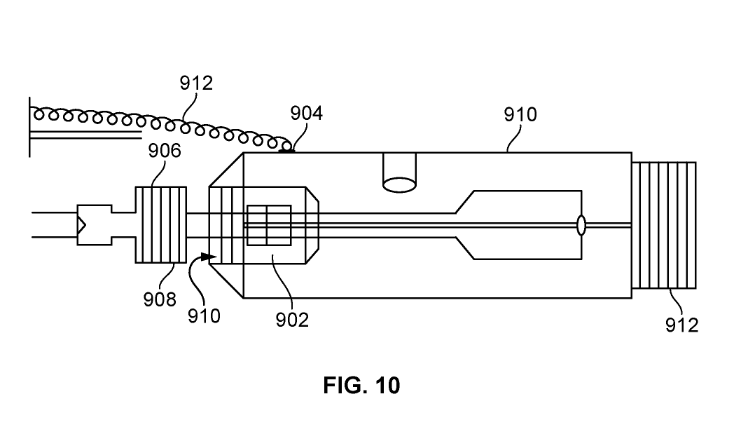

Turning now to FIG. 10A and FIG. 10B, a collapsible tank stand is schematically depicted. FIG. 10A is a schematic depiction of an illustrative embodiment of a collapsible tank stand setup and deployed and ready to support a tank. FIG. 10B is a schematic depiction of the collapsible tank stand collapsed and folded up for transport. The collapsible tank stand allows the collapsible tanks to be transport in a smaller volume when folded up. The tank stands are then unfolded and deployed after transport, saving transportation expenses by reducing the number of trucks need to transport the tank stands over the volume need to transport rigid tank stands that do not fold up and collapse.

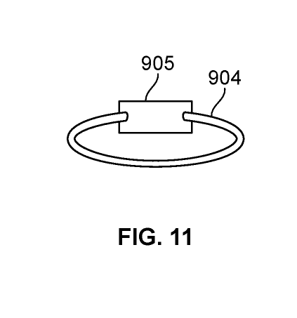

Turning now to FIG. 11, as shown in FIG. 11 in a particular illustrative embodiment, a hydraulic injection pump 1100 system is schematically depicted having a two-pump combination for providing a low-power consumption electrical solution to pumping injection fluid into a subterranean hydrocarbon-bearing formation. The two-pump system pumps injection fluid at a lower volume but at higher pressure that a conventional direct drive pump used to pump injection fluid into a formation. The two-pump system requires less electrical power to pump the same amount of injection fluid than using a conventional pump, such as a circulation pump. The two-pump combination is an improvement over the systems that use single convention pumps such as a circulation pump to pump a high volume at low pressure. In a particular illustrative embodiment of the invention, the first smaller pump 1102 pumps is used as an actuator to move the larger pump piston that pumps hydraulic fluid through hydraulic connection tube 1106 into the second larger pump 1104. In one illustrative embodiment of the invention, the smaller pump has a piston diameter of ¼ inch and the larger pump has a piston diameter of 6 inches. The small pump is caused to pump by moving the piston controlled by a solenoid or other suitable device to cause the small pump piston to reciprocate at a high rate using low electrical power. In a particular embodiment of the invention, the small pump piston reciprocates at 1 millisecond intervals. The small pump is driven by an electrical power source 1125. The large pump is driven by the hydraulic fluid pumped through the hydraulic connection tube 1106 from small pump. In a particular embodiment, the small pump is powered by electrical power source 1125. The small pump requires less electrical energy to pump the mid volume high pressure injection fluid to drive the -high be required to pump injection fluid using electrically energy to directly drive a conventional pump, such as a rotary pump directly. In a particular embodiment, a return line 1107 is provided to assist moving a piston 1110 in the high-power pump back up and returned to an up position after being piston has been driven down by the low-power pump. The return line further provides cooling of the hydraulic fluid in a reservoir 1111 in the return line hydraulic circuit. The cooling circuit substantially reduces over heating of the hydraulic fluid return line when the hydraulic fluid heats up during operation. Valves 1112 and 1114 are provided to return the hydraulic fluid through the return line from the high-power pump to the low-power pump.

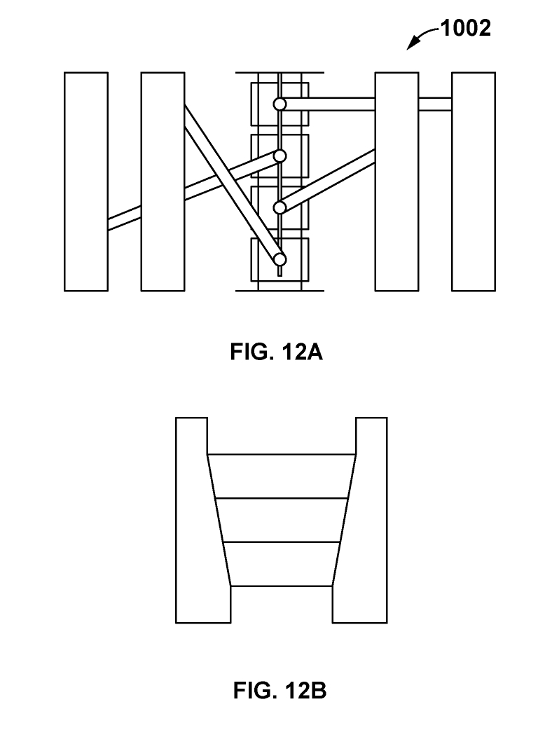

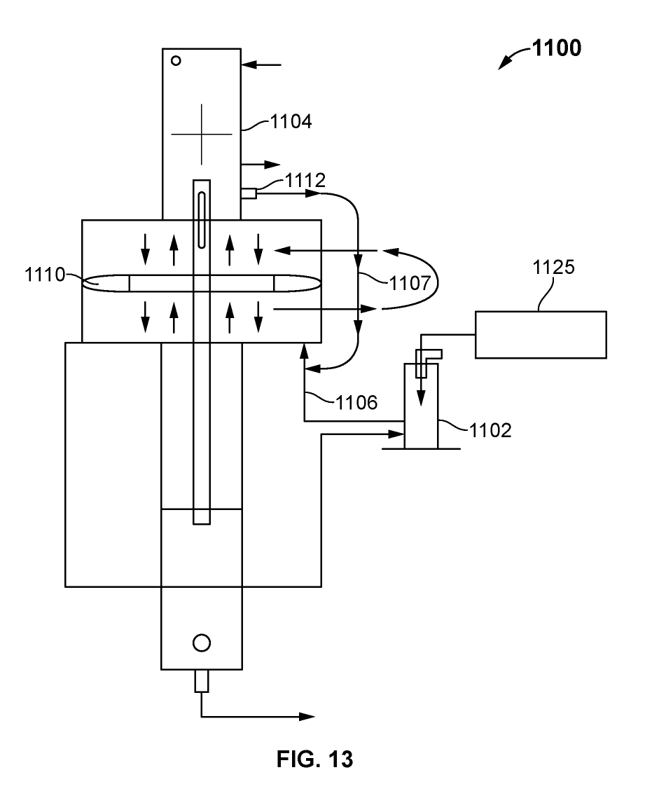

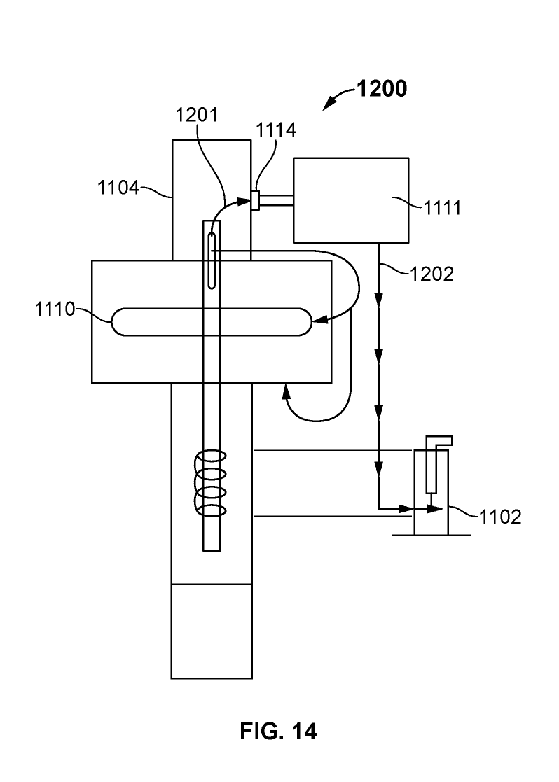

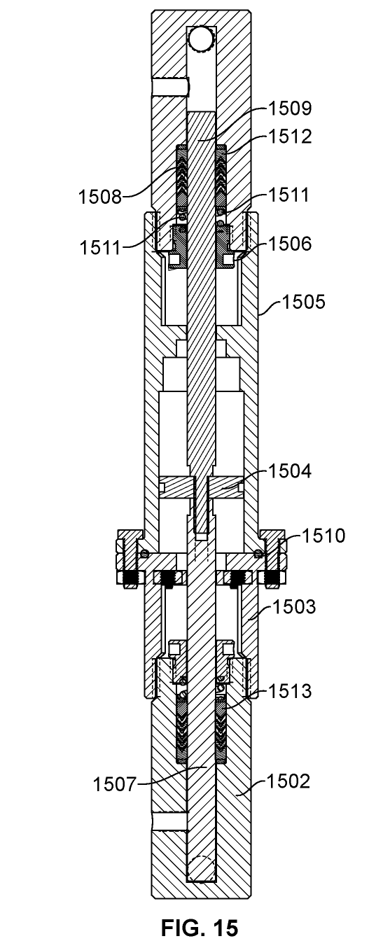

FIG. 12 is a diagrammatic representation of a machine in the form of a computer system 1200 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 1200 may include a processor 1202 (e.g., a central processing unit (CPU), a graphics processing unit (GPU), or both), a main memory 1204 and a static memory 1206, which communicate with each other via a bus 1208. The computer system 1200 may further include a video display unit 1210 (e.g., a liquid crystal display (LCD), a flat panel, a solid state display, or a cathode ray tube (CRT)). The computer system 1200 may include an input device 1212 (e.g., a keyboard), a cursor control device 1214 (e.g., a mouse), a disk drive unit 1216, a signal generation device 1218 (e.g., a speaker or remote control) and a network interface device 1220.

The disk drive unit 1216 may include a machine-readable medium 1222 on which is stored one or more sets of instructions (e.g., software 1224) embodying any one or more of the methodologies or functions described herein, including those methods illustrated in herein above. The instructions 1224 may also reside, completely or at least partially, within the main memory 1204, the static memory 1206, and/or within the processor 1202 during execution thereof by the computer system 1200. The main memory 1204 and the processor 1202 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 1224, or that which receives and executes instructions 1224 from a propagated signal so that a device connected to a network environment 1226 can send or receive voice, video or data, and to communicate over the network 1226 using the instructions 1224. The instructions 1224 may further be transmitted or received over a network 1226 via the network interface device 1220.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the programs and other various systems, components and functionalities described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are gene rally well known by those skilled in the art and, consequently, are not described in detail herein.

Flowcharts and Block Diagrams of the Figures show the functionality and operation of various specific embodiments of certain aspects of the present inventions. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a Turbomachine processor in a computer system or other system. The machine code may be converted from the source code, etc. if embodied in hardware, each block may represent a circuit or a number of interconnected circuits to implement the specified logical function(s).

Although the flowchart and block diagrams of the Figures show a specific order of execution, it is understood that the order of execution may differ from that Which is depicted. For example, the order of execution of two or more blocks may be scrambled relative to the order shown. Also, two or more blocks shown in succession in the Figures may be executed concurrently or with partial concurrence. Further, in some embodiments, one or more of the blocks shown in the Figures may be skipped or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present inventions.

Any logic or application described herein that comprises software or code can be embodied in any non-transitory computer-readable medium, such as computer-readable medium, for use by or in connection with an instruction execution system such as, for example, a Turbomachine processor in a computer system or other system. In this sense, the logic may comprise, for example, statements including instructions and declarations that can be fetched from the computer-readable medium and executed by the instruction execution system. In the context of the present inventions, a. “computer-readable medium” may include any medium that may contain, store, or maintain the logic or application described herein for use by or in connection with the instruction execution system.

The computer-readable medium may comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The Turbomachine processor may further include a network interface coupled to the bus and in communication with the network. The network interface may be configured to allow data to be exchanged between computer and other devices attached to the network or any other network or between nodes of any computer system or the video system. In addition to the above description of the network, it may in various embodiments include one or more networks including but not limited to Local Area Networks (LANs) (e.g., an Ethernet or corporate network). Wide Area. Networks (WANs) (e.g., the Internet), wireless data networks, some other electronic data network, or some combination thereof. In various embodiments, the network interface 159 may support communication via wired or wireless general data networks, such as any suitable of Ethernet network, for example; via telecommunications/telephony networks such as analog voice networks or digital fiber communications networks; via storage area networks such as Fiber Channel SANS, or via any other suitable type of network and/or protocol.

The Turbomachine processor may also include an input/output interface coupled to the bus and also coupled to one or more input/output devices, such as a display, a touchscreen, a mouse or other cursor control device, and/or a keyboard. In certain specific embodiments, further examples of input/output devices may include one or more display terminals, keypads, touchpads, scanning devices, voice or optical recognition devices, or any other devices suitable for entering or accessing data by one or more computers. Multiple input/output devices may be present with respect to a computer or may be distributed on various nodes of computer system, the system and/or any of the viewing or other devices shown in the Figures. In some embodiments, similar input/output devices may be separate from the Turbomachine processor and may interact with the Turbomachine processor or one or more nodes of computer system through a wired or wireless connection, such as through the network interface.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A reciprocating injection pump comprising:
a reciprocating block driven by a rotating gear, the gear having a substantially circular shape with four gear teeth formed on the rotating gear along approximately one fourth of the substantially circular shape, the rotating gear is attached to a rotating motor, the rotating motor having a right-angle motor shaft.

2. The pump of claim 1, wherein the motor shaft is connected to the right-angle motor a minimal distance minimizing the length of the motor shaft to reduce torque losses associated with longer shaft lengths.

3. The pump of claim 1, wherein the rotating gear is mounted on the motor shaft adjacent the motor from the entry point of the shaft to the motor to reduce torque loss incurred that would occur if the rotating gear was attached further away from the motor and thus having a longer shaft length from where the shaft exits the motor and attaches to the rotating gear.

4. The pump of claim 3, wherein the rotating motor shaft is directly coupled to rotating gear so that gear teeth are rotated by the rotating motor shaft and during rotation, the rotating gear teeth alternately engage the upper gear teeth and lower gear teeth formed inside of the block, wherein the rotating gear causes the reciprocating block to linearly translate back and forth along a longitudinal axis of a plunger.

5. The pump of claim 4, wherein the plunger drives an injection pump used to inject chemicals into a hydrocarbon bearing formation in an oil field.

6. The pump of claim 5, wherein the rotating gear rotates clockwise causing rotating gear teeth to alternately engage upper block gear teeth and moves the reciprocating block to the right along the longitudinal axis plunger.

7. The pump of claim 6, wherein after the rotating gear teeth exit the upper gear teeth the rotating gear teeth alternately engage lower block gear teeth and moves the reciprocating block to the left along the longitudinal axis plunger.

8. The pump of claim 7, wherein the plunger is used to pump injection fluids.

9. The pump of claim 8, wherein the reciprocating block is formed having a right end and a left end.

10. The pump of claim 8 wherein a single plunger is attached to the right end of the block.

11. The pump of claim 1, the pump further comprising:
a processor and computer readable medium having computer instructions stored therein that are executed by the process to control the stepper motor, wherein the motor is a stepper motor wherein the shaft of the stepper motor is directly coupled to rotating gear.

12. The pump of claim 11, wherein the stepper motor steps to rotate the motor shaft clockwise a programmable number of degrees less that a 360 degrees and less that full rotation of the motor shaft to move the right end of the lock to the right, and the processor then reverses the direction of the stepper motor to rotate the motor shaft counter clock wise programmable number of degrees less than 360 degrees and less than full rotation of the motor shaft to move the left end of the lock to the left.

13. The pump of claim 12, wherein the stepper motor enables the processor to move the block to the right a distance, for example 2 inches and move the block to the left a different distance, for example 1 inch.

14. The pump of claim 12, wherein the gear teeth are rotated by the stepper motor shaft clockwise so that the gear teeth engage the upper gear teeth so that the sand lower gear teeth formed inside of the block.

15. The pump of claim 14, wherein the stepper motor motion controlled by the stepper motor causes the reciprocating block to linearly translate back and forth along a longitudinal axis of a plunger.

16. The pump of claim 15, wherein the translation to the left is 1 inch and the translation to the right is 2 inches.

17. The pump of claim 16, wherein the first plunger and a second plunger are attached the left end of the block are caused to linearly translate along the longitudinal axis and wherein the reciprocating block drives both plungers back and forth along the common longitudinal axes of plungers, wherein the reciprocating block drives two plungers that are used to drive two fuel injection pumps.

18. The pump of claim 17, wherein three plungers are attached to the right end of the reciprocating block and another three plungers are attached to the left end of the reciprocating block the reciprocating block drives 6 plungers that are used to drive 6 pumps.

19. The pump of claim 17, wherein six plungers are attached to the right end of the reciprocating block and another six plungers are attached to the left end of the reciprocating block, wherein the reciprocating block drives 12 plungers and that are used to drive 12 pumps.

20. A method comprising:
rotating a gear in a reciprocating block driven by a rotating gear, the gear having a substantially circular shape with four gear teeth formed on the rotating gear along approximately one fourth of the substantially circular shape, the rotating gear is attached to a rotating motor, the rotating motor having a right-angle motor shaft, wherein the motor shaft is connected to the right-angle motor a minimal distance minimizing the length of the motor shaft to reduce torque losses associated with longer shaft lengths, wherein the rotating motor shaft is directly coupled to rotating gear so that gear teeth are rotated by the rotating motor shaft and during rotation, the rotating gear teeth alternately engage the upper gear teeth and lower gear teeth formed inside of the block, wherein the rotating gear causes the reciprocating block to linearly translate back and forth along a longitudinal axis of a plunger, wherein the rotating gear rotates clockwise causing rotating gear teeth to alternately engage upper block gear teeth and moves the reciprocating block to the right along the longitudinal axis plunger and wherein after the rotating gear teeth exit the upper gear teeth the rotating gear teeth alternately engage lower block gear teeth and moves the reciprocating block to the left along the longitudinal axis plunger and wherein the stepper motor steps to rotate the motor shaft clockwise a programmable number of degrees less that a 360 degrees and less that full rotation of the motor shaft to move the right end of the lock to the right, and the processor then reverses the direction of the stepper motor to rotate the motor shaft counter clock wise programmable number of degrees less than 360 degrees and less than full rotation of the motor shaft to move the left end of the lock to the left.
